(19) United States
(12) Patent Application Publication
(10) Pub. No.: US 2006/0039347 A1
(43) Pub. Date: Feb. 23, 2006

(54) Synchronous transmission network system

(75) Inventors: Kazuhiko Nakamura, Yokohama (JP); Masayuki Koga, Yokohama (JP); Junji Ono, Yokohama (JP); Hiroki Hamachi, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/992,079

(22) Filed: Nov. 19, 2004

(30) Foreign Application Priority Data
Aug. 18, 2004 (JP) 2004-238598

(51) Int. Cl. H04J 3/06

(52) U.S. Cl. 370/350; 370/503

(57) ABSTRACT

A synchronous transmission network system has a plurality of nodes including a plurality of clock supply nodes and all the nodes synchronize with a clock supplied from one of clock supply nodes as a master, wherein each clock supply node includes a transmission module for transmitting a quality request message toward all other nodes, a receiving module for receiving quality response messages from all the other nodes, a quality determination module for determining clock supply quality information, a notifying module for notifying other clock supply node serving as the master of the clock supply quality information, and a node determination module for determining an optimum clock supply node exhibiting the best clock supply quality on the basis of the notified clock supply quality information and the clock supply quality information of the self-node.

### BACKGROUND OF THE INVENTION

1. Field of the Invention

The present invention relates to a synchronous transmission network system.

2. Description of the Related Art

In a network synchronous digital transmission method typified by an SDH (Synchronous Digital Hierarchy) and a SONET (Synchronous Optical Network), it is required that a whole network is operated by one single clock source. For attaining this, clock signals exhibiting uniform high accuracy need spreading over the whole network. The reason why so is that if the synchronization can not be established due to deterioration of the clock accuracy, there occurs a loss of information that is called a slip.

As a matter of fact, however, in the process of distributing a clock to respective nodes (slave stations) from a node (master station) serving as a clock supply source, the clock accuracy gradually gets deteriorated as it is affected by a phenomenon called a wander occurred depending on a distance and a degree of refraction of an optical fiber cable for connecting between the nodes and on fluctuations in weather (temperature) and by a great variety of processes (a photoelectric signal conversion, and termination and generation of an SOH (Section OverHead)), etc. executed in the station.

Such being the case, the digital synchronous transmission system at the present adopts such a technology that each of the slave stations selects a clock exhibiting the highest accuracy from among the plurality of clocks (called clock sources) received via the optical fiber cable from the master station or the other slave stations, and captures this clock into the self-node, thereby keeping an intra-network synchronous quality high.

A measure for indicating the accuracy of the clock supplied involves utilizing an SSM (Sync Status Message) set in S1 bytes contained in the section overhead in a synchronous transfer module (STM-N). FIG. 25 shows the SSM (Generation 2) defined in GR as specifications for the SSM. A value set in Quality (quality) shown in FIG. 25 represents the accuracy of the clock, wherein the clock accuracy becomes higher as this numerical value gets smaller.

Herein, a clock selection method in the digital synchronous network that is adopted in the prior art will hereinafter be explained with reference to FIG. 26. FIG. 26 is a view showing an example of selecting the clock in the prior art. A network illustrated in FIG. 26 is configured by nodes A through F defined as digital transmission devices. A node A having a fixed oscillator 201 is a node capable of becoming a clock supply source. Similarly, a node D having a fixed oscillator 202 is also a node capable of becoming the clock supply source. Then, the nodes other than these nodes operate in synchronization with a clock supplied from the node A or D.

Herein, an operation in the case of selecting a clock source will be described by exemplifying the node C. The node C, in the case of selecting, as a clock source, the clock sent from any one of the node-A side and the node-E side, judges clock accuracy based on the SSM set in a section overhead field in a clock signal, and captures the clock exhibiting the higher accuracy into the self-node.

Further, in the case as shown in FIG. 26, to be specific, in the case where the SSMs extracted from the clock sources on the node-A side and the node-E side are the same message and exhibit the same accuracy (Quality=1), the node C captures into the self-node the clock of the clock source exhibiting a higher priority in accordance with a selection clock priority level 203 preset in the self-node.

Thus, in the clock source selection method according to the prior art, when selecting the clock that should be captured per node, the clock exhibiting the higher clock accuracy is selected from the SSMs set in the section overhead fields of the clock signals or is, if the clock accuracy of the clock signal is the same as the accuracy in terms of setting in the SSM, selected according to the priority in the selection clock priority level 203 set in each of the nodes.

In the clock source selection method according to the prior art, however, when building up a network, the priority of the selection clock source must be artificially judged and set per node on the basis of a topology at that point of time. Then, each time the network topology is changed, there occurs a change in accuracy of the clock reaching each node, and hence the priorities of the selection clock sources must be artificially reset again per node.

Moreover, the technology disclosed in Patent document 1 is that in a synchronous network as a loop type network configured in a ring type topology, the synchronization within the self-node is set based on the clock given from a transmission path having a small node-to-node relay count from the master station. In a network where a plurality of master stations exist, however, the whole network can not be synchronized with the clock supplied from one single master station in these master stations.

Note that a conventional art document concerning the present invention are as follows. The conventional art document is “Japanese Patent Application Laid-Open Publication No. 04-298199”.

### SUMMARY OF THE INVENTION

It is an object of the present invention to provide a synchronous transmission network in which each node automatically determines a master station for supplying an optimum clock.

The present invention adopts the following constructions in order to solve the problems described above. Namely, the present invention relates to a synchronous transmission network system, comprising a plurality of nodes including a plurality of clock supply nodes, all the nodes being synchronized with a clock supplied from one of clock supply nodes as a master and thus effecting a data transmission, wherein each clock supply node includes a transmission module for transmitting a quality request message for checking a quality of the clock supplied from a self-node to all other nodes, a receiving module for receiving quality response messages each containing clock quality information representing the clock quality from all the other nodes, a quality determination module for determining the quality of the clock supplied by the self-node as clock supply quality information on the basis of the quality response messages received by the receiving module, a notifying module for notifying, if the self-node is not the master, other clock supply node serving as the master of the clock supply quality information, and a node determination module for determining, if the self-node is the master, an optimum clock supply node exhibiting the best clock supply quality on the basis of the clock supply quality information which each of other clock supply nodes has notified of and the clock supply quality information of the self-node that is obtained by the quality determination module of the self-node.

According to the present invention, when a system constitution is changed, in a post-change system constitution, the optimum master station (optimum clock supply node) capable of supplying the optimum clock is determined.

For determining this optimum master station, the clock supply node requests other nodes to transmit clock qualities. The clock supply node adds up the clock qualities transmitted from the respective nodes other than the self-node, and thus determines the clock supply quality in the self-node. The clock supply node, which has determined the clock supply quality, transmits the clock supply quality to a clock supply node that becomes a master. Then, the clock supply node serving as the master adds up the clock supply qualities sent by the respective clock supply nodes, and thus determines the optimum master station exhibiting the best clock supply quality among these clock supply qualities.

Therefore, according to the present invention, as in the case of changing the network constitution, the clock supply node exhibiting the highest supply clock quality can be automatically determined.

Further, the present invention relates to the synchronous transmission network system, wherein each of the clock supply nodes includes a judging module for judging whether or not the optimum clock supply node determined by the node determination module is the self-node, and an optimum master station notifying module for sending, if the judging module judges that the optimum clock supply node is not the self-node, an optimum master station notifying message for indicating a receipt of a clock supply from the optimum clock supply node toward all the other nodes.

According to the present invention, when judging that the optimum master station is not the self-node, each of the nodes within the system is notified of the optimum master station notification message so as to change the optimum master station. Then, each node having received the optimum master station notification message captures the clock with the top priority, which is supplied by the optimum master station, and then operates.

Hence, according to the present invention, all the nodes within the system can be automatically synchronized with the optimum clock.

Further, the present invention relates to the synchronous transmission network system, wherein each of the nodes includes a quality request receiving module for receiving the quality request message, a quality response creation module for creating the quality response message responding to the quality request message received by the quality request receiving module, a quality response transmission module for transmitting the quality response message, addressed to a source node of the quality request message, in a direction of receiving the quality request message, and a quality transfer module for transferring, if the quality request receiving module has a receiving direction different from the quality request message receiving direction, the quality request message in this different receiving direction.

According to the present invention, the clock supply node requests the respective nodes to transmit the clock qualities, in each of the nodes, of the clocks supplied by the self-node. Each node receiving the request calculates the clock quality, in the self-node, of the clock supplied by the clock supply node as the requester. Then, each node sends, as a response, this clock quality back to the clock supply node as the requester. Moreover, each node which the clock quality is requested of, in the case of having a receiving direction different from the quality request message receiving direction, transfers the quality request message in this different direction.

Therefore, according to the present invention, the quality request message is received by all the nodes not only in the network constitution (topology) in which the clock supply node is connected to each node in a peer-to-peer but also in the constitution (the ring type topology) in which the clock supply node is connected via other nodes.

According to the present invention, each of the nodes configuring the synchronous transmission network system can automatically determine the master station for supplying the optimum clock.

### BRIEF DESCRIPTION OF THE DRAWINGS

FIG. 1 is a view showing a network constitution in an embodiment of the present invention;

FIG. 2 is a diagram showing functional blocks of a digital transmission device in the embodiment of the present invention;

FIG. 3 is a view showing a modified example of the network constitution in the embodiment of the present invention;

FIG. 4 is a diagram showing node identifiers;

FIG. 5 is a view showing how a quality request is sent from a sub-master station A;

FIG. 6 is a diagram showing the quality request given from a node A;

FIG. 7 is a view showing how the quality request and a quality response are sent from a node E;

FIG. 8 is a diagram showing the quality request given from the node E;

FIG. 9 is a diagram showing the quality response given from the node E;

FIG. 10 is a diagram showing a database in the node E;

FIGS. 11A and 11B are flowcharts showing a flow of quality response setting process;

FIG. 12 is a flowchart showing a flow of quality request receiving process;

FIG. 13 is a flowchart showing a flow of quality response receiving process;

FIG. 14 is a diagram showing a clock supply quality determination method;

FIG. 15 is a view showing how a piece of supply quality notification is sent from the node A;

FIG. 16 is a diagram showing the supply quality notification given from the A;

FIG. 17 is a flowchart showing a flow of supply quality notification receiving process;

FIG. 18 is a diagram showing an optimum master station determination method;

FIG. 19 is a flowchart of optimum master station notification judging process;

FIG. 20 is a view showing how the optimum master station notification is sent from a node D;

FIG. 21 is a diagram showing a piece of quality best station notification given from the node D;

FIG. 22 is a view showing an automatic change of a selection clock in the node E;

FIG. 23 is a flowchart showing a flow of optimum master station receiving process;

FIGS. 24A and 24B are diagrams showing a processing sequence of the present invention;

FIG. 25 is a diagram showing an SSM (Generation 2); and

FIG. 26 is a view showing an example of a clock selection in the prior art.

### DESCRIPTION OF THE PREFERRED EMBODIMENTS

An embodiment of the present invention will hereinafter be described with reference to the drawings. A configuration in the embodiment is given by way of exemplification, and the present invention is not limited to the configuration in the embodiment.

### Outline of Embodiment

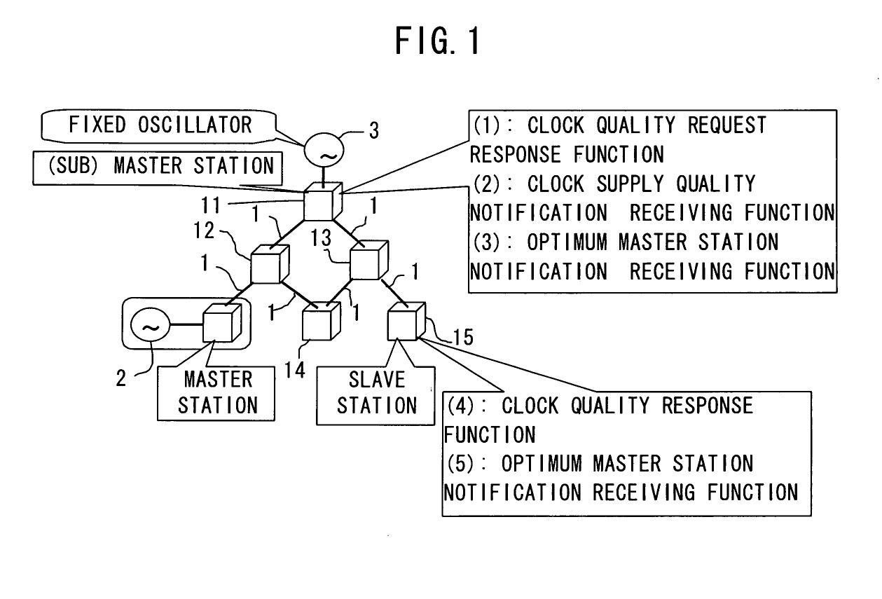

Discussion on the embodiment of the present invention starts with explaining an outline of the embodiment of the present invention. FIG. 1 is a view showing a network constitution in the embodiment of a synchronous transmission network system according to the present invention. The embodiment is that a digital synchronous transmission system is configured by a network in which a plurality of transmission devices (which are also termed [nodes]) 10 through 15 are connected via optical fibers 1.

The respective transmission devices configuring the network system are classified into a master station, a sub-master station and slave stations. Some nodes (which are the nodes 10, 11 in FIG. 1) in the plurality of nodes, which include fixed oscillators serving as clock sources, are capable of supplying other nodes with clocks based on these fixed oscillators. The node having the fixed oscillator (which will hereinafter be referred to as [a clock supply node]) can become the master station or the sub-master station. In the clock supply nodes, the node capable of supplying all other nodes with the clock exhibiting the highest accuracy within the network becomes the master station. In an example shown in FIG. 1, the node 10 including a fixed oscillator 2 is the master station. Further, the clock supply node other than the clock supply node having become the master station becomes the sub-master station. In the example shown in FIG. 1, the node 11 including a fixed oscillator 3 is the sub-master station. Then, the respective nodes inclusive of (subjected to) the clock supply nodes become the slave stations under the master station and the sub-master station, respectively. In the example shown in FIG. 1, the respective nodes excluding the node 10 serving as the master station are the slave stations under the node 10. Further, the respective nodes exclusive of the node 11 serving as the sub-master station are the slave stations under the node 11. The slave station can synchronize with the clock supplied from the master station by use of a synchronous oscillator possessed by the slave station itself.

Thus, the digital transmission system is configured so that any one of the plurality of nodes building up the network becomes the master station, the master station supplies the other nodes with the clocks, and each node performs an operation such as transmitting and receiving signals (data transmission) in a way that synchronizes with the clocks supplied therefrom. Then, if a fault occurs in the node serving as the master station, one of the clock supply nodes serving as the sub-master stations is employed as the master station.

In the network, it is changeable depending on a topology to determine which clock supply node becomes the master station. Namely, there is a possibility that the master station changes as the network topology changes. Note that as in the case of the nodes 10 and 11 shown in FIG. 1, the nodes having the fixed oscillators serving as the clock sources correspond to the clock supply nodes according to the present invention.

In the following discussion, the respective nodes might be represented as [the master station], [the sub-master station] and [the slave stations].

The digital synchronous transmission system in the embodiment determines a clock quality to the whole network with respect to each of the clock signals supplied from the master station 10 and the sub-master station 11 (which are the clock supply nodes) having the clock sources in possession. The clock quality is what digitizes (numeralization) a node-to-node relay count (a hop count), a connection distance, a circuit alarm occurrence count, a circuit switchover count, etc. which are given from the clock supply nodes, and represents a degree of deterioration of the clock supplied from the clock supply node.

Then, the digital synchronous transmission system determines a node capable of supplying the clock exhibiting the highest clock quality (which is called [an optimum master station] and corresponds to an optimum clock supply node according to the present invention) in the clock supply nodes.

In determining the optimum master station, if the clock supply node different from the clock supply node remaining to be the master station at the present is determined to be the optimum master station, the master station is changed from the present master station to the clock supply node determined to be the optimum master station. For example, a selection clock priority level in each node is automatically changed. The selection clock priority level connotes a priority level of the clock that should be taken in by each of the nodes configuring the network system. A clock priority order is determined in the sequence of the clock accuracy from the highest.

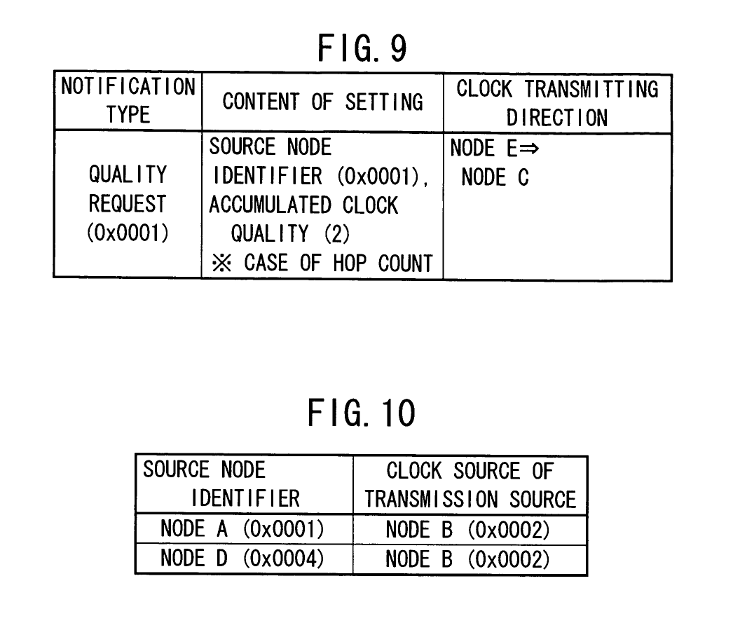

The digital synchronous transmission system actualizes functions related to determining the clock quality, determining the optimum master station and changing the master station by transferring and receiving the clock quality information between the nodes. The clock quality information can be set in, for instance, a user channel F1 byte, etc. of an overhead byte provided on a section overhead within the clock signal (SDH or SONET frame) transmitted and received between the nodes. Further, items such as a [quality request], a [quality response], a [supply quality notification] and an [optimum master station notification] are defined in the clock quality information, whereby a setting content corresponding to each item can be determined. For example, it is possible to configure such a scheme as to have setting contents for the [quality request] as in FIGS. 6 and 9, a setting content for the [quality response] as in FIG. 8, a setting content for the [supply quality notification] as in FIG. 16 and a setting content for the [optimum master station notification] as in FIG. 21, respectively.

For transferring and receiving the clock quality information, the master station and the sub-master station have [1] a clock quality request/response function, [2] a clock supply quality notifying/receiving function, and [3] an optimum master station notifying/receiving function. On the other hand, the slave station has [4] a clock quality response function and [5] an optimum master station notifying/receiving function.

[Constitution of Node]

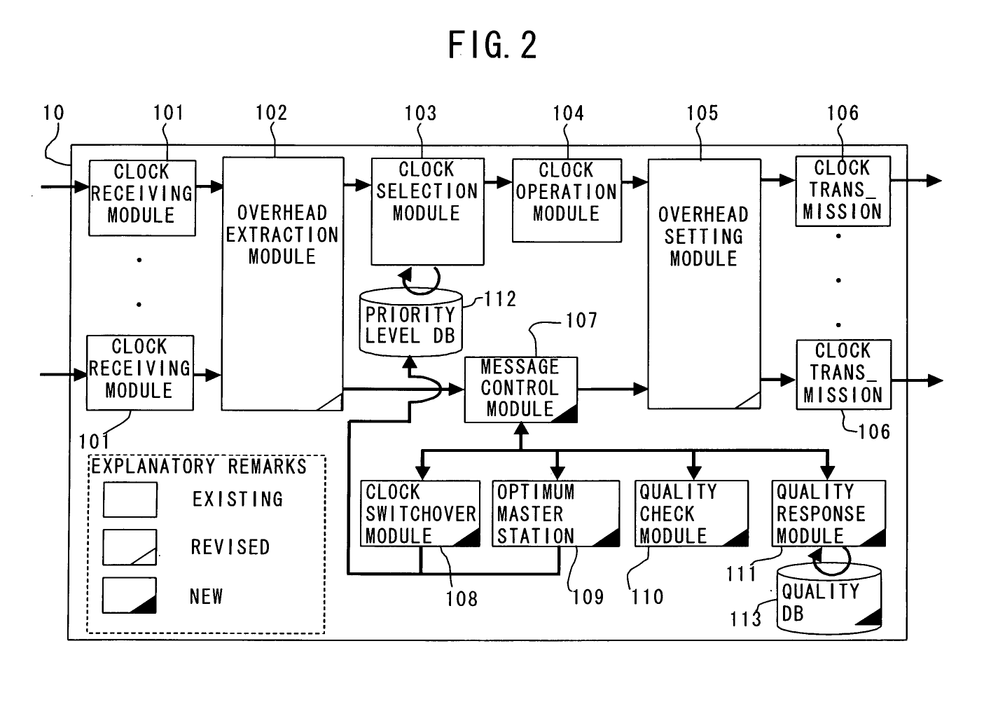

Next, a functional constitution possessed by each node will be explained. FIG. 2 is a functional block diagram of each of the digital transmission devices (nodes) building up the network illustrated in FIG. 1. Each node is constructed of a CPU (Central Processing Unit), a memory, an I/O interface and so on. The CPU executes programs stored on the memory, thereby actualizing the respective functions shown in FIG. 2. Note that the individual functions shown in FIG. 2 have the same structures throughout the master station, the sub-master station and the slave station, and operate corresponding to a role of the individual station. FIG. 2 shows the node 10 by way of an example.

Each of the functional blocks of the digital transmission device will individually be explained.

(Clock Receiving Module)

A clock receiving module 101 captures the clock signal via the optical fiber 1, and executes a photoelectric conversion, SOH (Section OverHead) termination, a multiplex conversion process (multiplexer process), etc. upon this clock signal.

(Overhead Extraction Module)

An overhead extraction module 102 receives the clock signal from the clock receiving module 101. The overhead extraction module 102 extracts pieces of information from the section overhead within the clock signal (which will hereinafter be termed an [intra-clock overhead]), and executes a frame synchronizing process, a fault detection process such as cut-off of an input signal (LOS), a desynchronized frame (LOF), etc. a clock quality (QL) acquisition process, a path setting normality check (path trace) and so on.

The overhead extraction module 102 extracts the clock quality information contained in the clock signal. The overhead extraction module 102, when having extracted the clock quality information, transfers the clock quality information to a message control module 107 and requests for a process related to the clock quality information. Further, the overhead extraction module 102 transfers the clocks contained in the clock signals to a clock selection module 103.

(Clock Selection Module)

The clock selection module 103 selects a clock exhibiting the highest accuracy among the clocks from every clock supply node, which have been transferred from the overhead extraction module 102. To be specific, the clock selection module 103 refers to a priority level database (priority level DB) 112, thus selecting the clock exhibiting the highest selection clock priority level set in the priority level DB 112. The clock selection module 103 gives the selected clock to a clock operation module 104.

(Clock Operation Module)

The clock operation module 104 captures, into the self-node, the clock selected by the selection module 103, and sets this clock in the clocks to be transmitted from the self-node.

(Overhead Setting Module)

An overhead setting module 105 receives the clock from the clock operation module 104. The overhead setting module 105 sets, in the intra-clock overhead, the fault information about the cut-off of the input signal (LOS), the desynchronized frame (LOF), etc., the clock quality, a sequence for the path setting check, and so on. The clock quality information is herein set by the overhead setting module 105.

(Clock Transmission Module)

A clock transmission module 106 receives the clock set by the overhead setting module 105. The clock transmission module 106 executes a demultiplex conversion process (demultiplexer process), generation of SOH and the photoelectric conversion process upon the clock signal, and transmits the post-processing clock signal to the optical fiber 1.

(Message Control Module)

A message control module 107 analyzes the clock quality information extracted by the overhead extraction module 102, and requests a clock switchover module 108, an optimum master station selection module 109, a quality check module 110 and a quality response module 111 for a process corresponding to every item of the clock quality information. Moreover, the message control module 107, when receiving notifications of processed results from the clock switchover module 108, the optimum master station selection module 109, the quality check module 110 and the quality response module 111, requests the overhead setting module 105 to set the clock quality information according to the necessity.

(Quality Check Module)

The quality check module 110 requests a clock quality check with respect to each of other nodes. Namely, the quality check module 110 requests the message control module 107 to set the [quality request]. Further, the quality check module 110 adds up the clock qualities sent from other respective nodes, and determines the worst quality clock among those as a clock supply quality of the self-node. Then, the quality check module 110 requests the message control module 107 to notify the master station of the thus determined clock supply quality.

(Quality Response Module)

The quality response module 111 calculates the clock quality of the clock signal having reached the self-node in response to the [quality request] requested by the quality check module 110, and requests the message control module 107 to get this clock quality responded. The quality response module 111 calculates the clock quality in the self-node by use of the clock quality in the self-node that is stored on a quality DB 113 and the accumulated clock qualities up to the self-node, which have been sent from the other nodes.

(Optimum Master Station Selection Module)

The optimum master station selection module 109 adds up the clock supply qualities sent from the respective clock supply nodes, and selects a node exhibiting the highest supply quality as an optimum master station (quality best station). Further, the optimum master station selection module 109 requests the message control module 107 to notify other respective nodes of this optimum master station.

(Clock Switchover Module)

The clock switchover module 108 changes a priority of the selected clock, which is stored in the priority level DB 112, on the basis of the optimum master station selected by the optimum master station selection module 109. The clock switchover module 108 corresponds to a registration control module according to the present invention.

(Priority Level DB)

The priority level DB 112 is a database for retaining the priority of the selected clock. In the priority level DB 112, pieces of clock source information through which the clocks should be captured are defined in the sequence of the priority level for each of the clocks supplied from the master station and the sub-master station. The clock source information for capturing the clock supplied from the optimum master station, is set with the highest priority level. The priority level DB 112 corresponds to a registration module according to the present invention.

(Quality DB)

A quality DB 113 is a database for retaining the clock quality of the self-node.

In the constitution, the clock receiving module 101, the overhead extraction module 102, the message control module 107, the quality check module 110, the overhead setting module 105 and the clock transmission module 106 correspond to a transmission module, a receiving module, a quality determining module and a notifying module according to the present invention. Further, the optimum master station selection module 109 mainly corresponds to a node determining module, a judging module and an optimum master station notifying module according to the present invention. Moreover, the quality response module 111 mainly corresponds to a quality request receiving module, a quality response creating module, a quality response transmission module and a quality transfer module according to the present invention.

In the embodiment, the above functional modules shown in FIG. 2 have the same structures throughout all the nodes of the master station, the sub-master station and the slave stations, however, the unnecessary functional module can be omitted corresponding to the role of each node. The quality check module 110 is an indispensable function when the self-node is the clock supply node. Further, the optimum master station selection module 109 is an indispensable function when the self-node is the master station. Hence, the optimum master station selection module 109 and the quality check module 110 may be deleted in the dispensable nodes.

Moreover, in the digital transmission device shown in FIG. 2, the respective blocks represented by existing symbols are the components of the conventional digital transmission device, the individual blocks represented by revised symbols are functions actualized by revising the conventional components, and the respective blocks represented by new symbols are components prepared afresh for actualizing the present invention. Thus, the digital transmission device can be actualized by improving the conventional transmission device, and hence development costs thereof can be restrained,

<Operation of Each Function>

Next, operations of the above functional blocks will be described with reference to FIGS. 1 and 2. To begin with, the operation of the above functional block in the process of determining the clock quality will be explained.

On the occasion of determining the clock quality, at first, in the master station 10 and the sub-master station 11 having the clock sources, the quality check module 110 requests the message control module 107 to send the clock quality check request.

Next, the message control module 107 requests the overhead setting module 105 to set the clock quality check request. Subsequently, the overhead setting module 105 sets the [quality request] and a [source node identifier] as an identifier of the self-node in the intra-clock overhead.

Then, the clock transmission module 106 transmits the clock signal to the other nodes to which the self-node is connected. Namely, the clock signal is, when the self-node is the master station, transmitted to the individual slave stations including the sub-master station. The clock signal is, when the self-node is the sub-master station, transmitted to the respective slave stations including the master station.

Then, in each node having received the clock signal, the clock receiving module 101 captures the clock signal. Next, the overhead extraction module 102 analyzes the intra-clock overhead. The overhead extraction module 102, in the case of extracting the [quality request] from the overhead, requests the message control module 107 to process the [quality request].

The message control module 107 requests the quality response module 111 to calculate a clock quality having arrived at the self-node. The quality response module 111 calculates the clock quality of the clock signal having reached the self-node on the basis of the quality DB 113 and the accumulated clock qualities up to the arrival at the self-node, which have been set in the overhead. Subsequently, the quality response module 111 notifies the message control module 107 of the thus calculated clock quality.

The message control module 107 requests the overhead setting module 105 to send a [quality response] according to the [quality request] received this time and to transfer the [quality request] to the other nodes. The overhead setting module 105 sets the [quality response], the [clock quality] and a [destination node identifier] in the intra-clock overhead that should be transmitted back to a recipient of the [quality request] in order to set, in the overhead, the [quality response] according to the [quality request) received previously.

At this time, the overhead setting module 105 sets the clock quality calculated by the quality response module 111 as the [clock quality]. Further, the overhead setting module 105 sets the [source node identifier] that has been set in the intra-clock overhead with respect o the [quality request] received previously as the [destination node identifier].

Moreover, the overhead setting module 105 sets the [quality request], the [source node identifier] and the [accumulated clock qualities] in the intra-clock overhead that should be transmitted in directions other than the direction of having received the [quality request] in order to set the transfer of the [quality request] to the other nodes. At this time, the overhead setting module 105 sets, in the [accumulated clock qualities], the clock quality calculated by the quality response module 111. The clock signal containing respectively the [quality response] and the [quality request] is given to the clock transmission module 106 corresponding to the destination thereof. Then, each clock transmission module 106 sends the clock signal to the node.

The clock signal containing the [quality response] is received by the clock receiving module 101 in each of the master station and the sub-master station that have sent the [quality request] associated with this [quality response], and is given to the overhead extraction module 102.

Hereat, the overhead extraction module 102 extracts the [quality response] by analyzing the intra-clock overhead and, if the [destination node identifier] is the ID (identifier) of the self-node, notifies the quality check module 110 of the quality response via the message control module 107. Then, the quality check module 110 adds up the [click qualities] calculated in the respective nodes which are set in the clock signals, and determines, as the [clock supply quality] when the self-node supplied the clock, the worst value among the [clock qualities].

Given next is an explanation of operations of the above functional blocks in the process of determining the optimum master station. When the quality check module 110 in the sub-master station determines the clock supply quality as described above, the message control module 107 is notified of this clock supply quality. Subsequently, the message control module 107 requests the overhead setting module 105 to send [supply quality notification] in the direction of the master station. Next, the overhead setting module 105 sets the [supply quality notification], the [destination node identifier], the [source node identifier] and the [clock supply quality] in the intra-clock overhead of the clock signal that should be sent in the direction of the master station.

Herein, the overhead setting module 105 sets an identifier (ID) of the master station as the [destination node identifier], sets an identifier of the self-node (the sub-master station) as the [source node identifier], and sets the clock supply quality determined previously by the quality check module 110 as the [clock supply quality]. Then, the clock signal, in which these items are set, is transmitted by the clock transmission module 106.

The clock receiving module 101 in the master station, which has received the clock signal, captures the clock signal. Next, the overhead extraction module 102, when extracting the [supply quality notification] by analyzing the intra-clock overhead, requests the message control module 107 to execute the process.

The message control module 107 notifies the optimum master station selection module 109 of the clock supply qualities of the respective sub-master stations. The optimum master station selection module 109 determines, as the optimum master station, the master station or the sub-master station exhibiting the best value of the [clock supply quality] among the [clock supply qualities] notified. Further, the optimum master station selection module 109 makes a change in the priority level DB 112 so that the clock reached from the determined optimum master station is to be captured with the first priority.

Given next is a description of operations of the above functional blocks in the process of requesting all the nodes to change the selected clock priority level so that the first priority is given to the optimum master station.

The optimum master station selection module 109 in the present master station, when determining the optimum master station in the way described above, judges whether or not this optimum master station is different from the present master station. Herein, if judged to be a different node, the optimum master station selection module 109 notifies the message control module 107 of the optimum master station. Next, the message control module 107 requests the overhead setting module 105 to notify the every-directional node of the optimum master station.

The overhead setting module 105 sets the [optimum master notification] and the [optimum master station node identifier] in the intra-clock overhead that should be transmitted in every direction of the node. Herein, the identifier of the optimum master station is set in the [optimum master station node identifier]. Then, the clock signal, in which these items are set, is transmitted by the clock transmission module 106. At this time, the present master station is changed from the master station to the sub-master station.

The clock receiving module 101 in each node having received the clock signal captures the clock signal. Next, the overhead extraction module 102, when extracting the [optimum master station notification] by analyzing the intra-clock overhead, notifies the clock switchover module 108 of the optimum master station via the message control module 107.

Then, the clock switchover module 108 makes a change in the priority level DB 112 so that the first priority is given to the clock arriving from the optimum master station. Further, if the optimum master station is the self-node, there is a change from the sub-master to the master station.

<System Constitution>

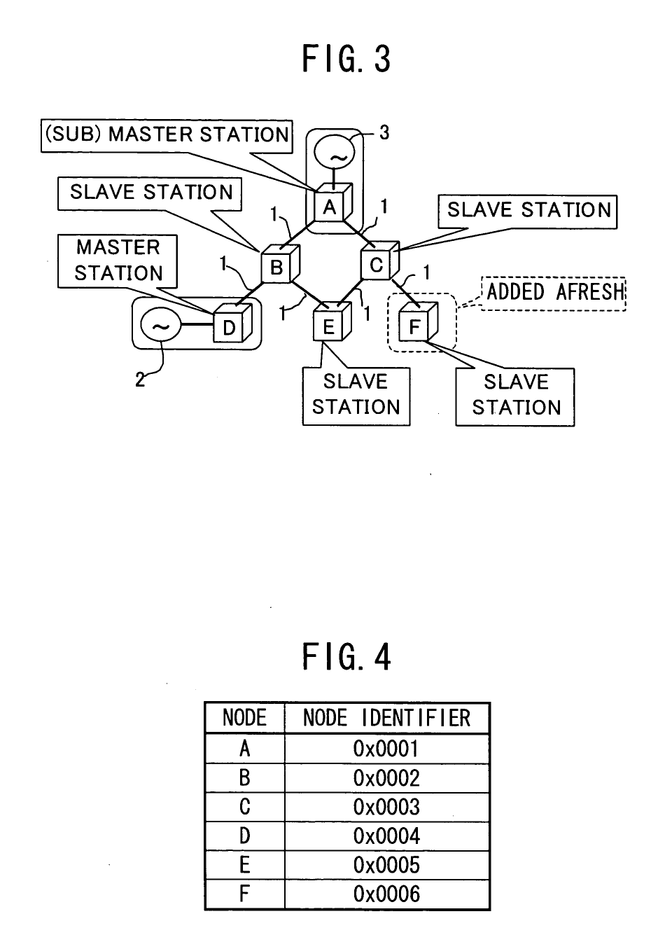

FIG. 3 is a view showing an example in the case of changing the network constitution (topology) in the digital synchronous transmission system illustrated in FIGS. 1 and 2. In FIG. 3, each of digital transmission devices (nodes) D, A, B, C, E, F corresponding to the nodes 10, 11, 12, 13, 14, 15 shown in FIG. 1, are connected via the optical fibers 1. Each of the digital transmission devices A through F has the structure illustrated in FIG. 2. Moreover, the digital transmission devices A through F are classified into a master station D having the fixed oscillator 2, a sub-master station A having the fixed oscillator 3 exhibiting the same accuracy as a clock source of the master station D has, and slave stations (A through F including the master station and the sub-master station as well) synchronizing with the clock given from the master station D or the sub-master station A.

The digital synchronous transmission system illustrated in FIG. 3 is configured at the beginning by five pieces of nodes, i.e., the nodes A through F and operating with the node D serving as a master station and the node A serving as a sub-master station, wherein the network constitution (topology) of the system is changed by adding afresh the node F having none of the fixed oscillator.

Moreover, node identifiers for identifying the respective nodes within the system are assigned to the nodes A through F. FIG. 4 shows the node identifiers assigned to the respective nodes in the embodiment of the present invention. Each node stores a memory of the self-node with the identifier of each self-node.

<Operational Example>

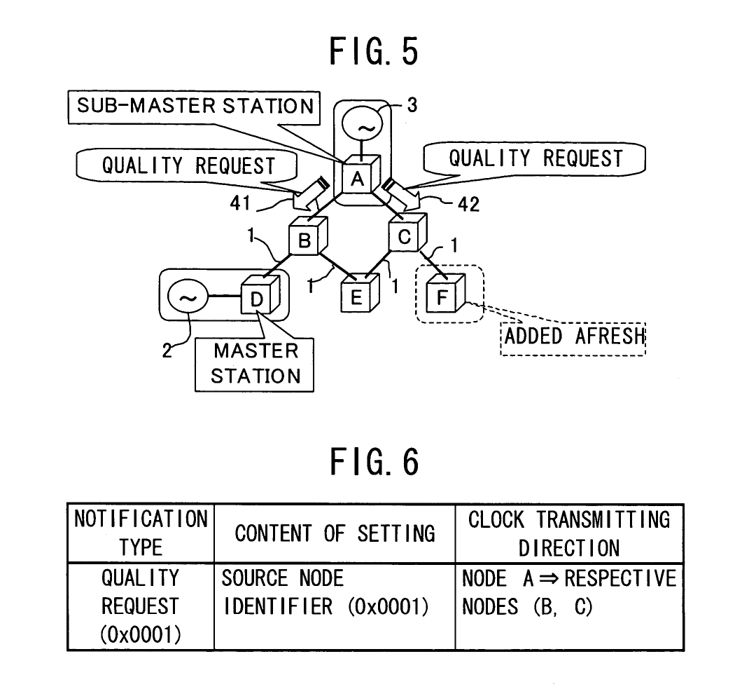

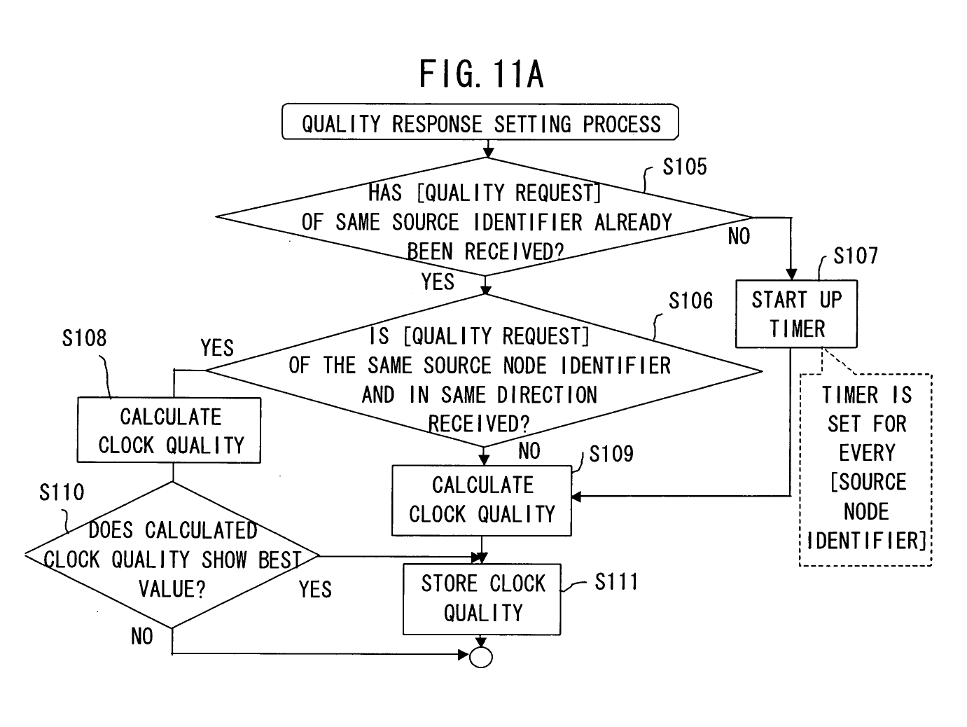

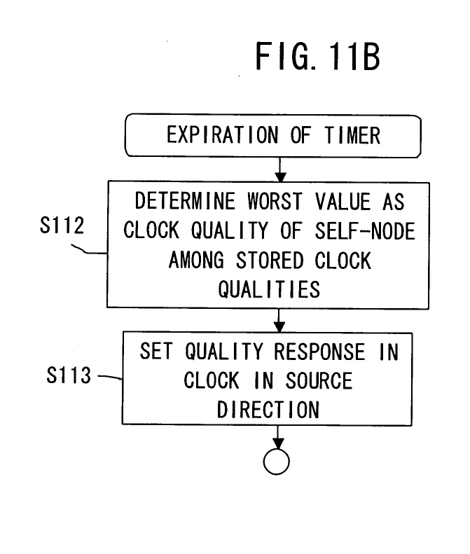

An operational example of the digital synchronous transmission system in the embodiment of the present invention, i.e., an operational example of each node in the case of changing the network constitution in the digital synchronous transmission system in the embodiment of the present invention, will hereinafter be described with reference to FIGS. 5 to 23 inclusive. FIGS. 5, 7, 14, 15, 18, 20 and 22 are diagrams showing an outline of the operational example of each of the nodes configuring the system of the present invention. FIGS. 11, 12, 13, 17, 19 and 23 are flowcharts showing the operational example of each node. FIGS. 6, 8, 9, 10, 16 and 21 are tables showing contents of data of the clock quality information transferred and received between the nodes.

The master station D and the sub-master station A transmit the clock signal with a [quality request] set therein (which signal will hereinafter be referred to as the [quality request]) in directions of other nodes connected thereto. For facilitating the understanding of the discussion, the explanation will hereinafter be made in a way that focuses a case where the [quality request] is sent from the sub-master station A by omitting the case of sending the [quality request] from the master station D.

The [quality request] may also be periodically sent from the master station and the sub-master station (clock supply node). Alternatively, the master station and the sub-master station may send the [quality request] in accordance with control given from a maintenance terminal (OPE (unillustrated)) of the digital transmission system. In this instance, for example, when the network topology is changed as in the case of adding the node F, the transmission of the [quality request] may be started by operating the maintenance terminal.

FIG. 5 shows how the [quality request] is sent from the sub-master station A in the digital transmission system. FIG. 6 shows contents of a [quality request] 41 and a [quality request] 42 sent from the sub-master station A shown in FIG. 5. Set in the intra-clock overhead at this time are, as shown in FIG. 6, an identifier (0x0001) for identifying the quality request and a node identifier for identifying the self-node as a source node identifier, i.e., a node identifier (0x0001) of the sub-master station A.

Each node receiving the above [quality request] 41, 42 sends a clock signal with a [quality response] (which signal will hereinafter be termed a [quality response]) set therein in the direction of the sub-master station A.

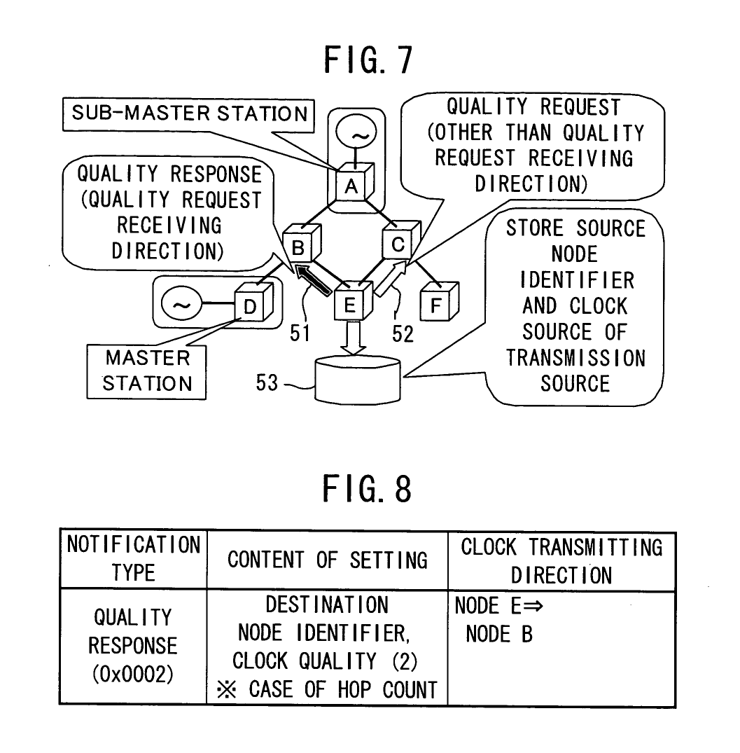

FIG. 7 shows how the node E sends the [quality response] and the [quality request] in the case of receiving the [quality request] transferred from the node B. An operation in the case where the node E receives the [quality request] transferred from the node B, will hereinafter be described with reference to FIG. 7. The node E, when receiving the [quality request] from the sub-master station A via the node B, sends a [quality response] 51 in the [quality request] receiving direction (node-B direction).

FIG. 8 shows contents set in the intra-clock overhead of the [quality response] 51 sent by the node E. Set in the intra-clock overhead are an identifier (0x0002) for identifying the quality response, a clock quality calculated in the self-node as the clock quality and a source node identifier (the node identifier “0x0001” of the sub-master station A) set in the [quality request] transferred from the node B as the destination node identifier. In the embodiment, the clock quality involves using a node-to-node relay count (hop count). With this count used, the clock quality set in the overhead becomes “2”.

Further, the node E, when receiving the [quality request], sends the [quality request] 52 in a direction other than the direction (node-C direction) of receiving this [quality request]. FIG. 9 shows contents set in the intra-clock overhead of the [quality response] 52 sent by the node E at this time. Set in the intra-clock overhead are an identifier (0x0001) for identifying the quality request, a clock quality calculated in the self-node as the accumulated clock quality and a source node identifier (the node identifier “0x0001” of the sub-master station A) as the source node identifier. The accumulated clock quality set herein is used for calculating the clock quality of the self-node in a next node (node C) having received the [quality request].

Moreover, the node E, when receiving the [quality request], stores a database 53 in the self-node with the source node identifier set in this [quality request] and the source node having sent the [quality request].

FIG. 10 shows a clock source table stored on the database 53 in the node E at this time. The clock source table shown in FIG. 10 is stored with the source node identifier (the node identifier (0x0001) of the sub-master station A) set in the [quality request] transferred from the node B and with the node identifier (the node identifier “0x0002” of the node B) of the clock source of the transmission source that has sent the [quality request].

Namely, FIG. 10 shows that the node B (the identifier “0x0002) is a clock source of the clock signal supplied by the node A (the node identifier “0x0001”) and that the node B (the node identifier “0x0002”) is a clock source of the clock signal supplied by the node D (0x0004).

This clock source table is utilized for knowing a sending direction in such a case that the node E gives a response to, e.g., the master station D or the sub-master station A, and for knowing a clock capturing direction of the clock from a post-change master station when the master station has been changed.

The discussion made so far has, for facilitating the understanding, dealt with the case in which the node E receives the [quality request] sent by the sub-master station A via the node B. There is, however, a case where the [quality request] might be received via the node C.

Namely, there is considered a case in which each node might receive a plurality of [quality requests] from the same source node identifier. An operation of the node E in this case will be explained with reference to FIG. 11 (FIGS. 11A and 11B). FIG. 11 (FIGS. 11A and 11B) is a flowchart of the operation related to a [quality response] setting process of each node having received the [quality request].

The node E, when receiving the [quality request], judges whether or not the [quality request] of the same source node identifier has already been received with respect to the [quality request] (S105). If not yet received (S105; NO), the node E starts up a timer for a preset fixed period (S107), then calculates the clock quality from pieces of information set in the [quality request] (S109), and stores this clock quality (S111).

Further, the node E, if the [quality request] of the same source node identifier has already been received (S105; YES), judges whether or not this [quality request] is what is sent in the same direction as the previous [quality request] and from the same source node identifier (S106). If this [quality request] is judged to be what is sent in the same direction as the previous [quality request] and from the same source node identifier (S106; YES), the node E calculates the clock quality (S108), then compares the thus-calculated clock quality with the previously-calculated clock quality (S110), and, if the clock quality calculated this time shows the best value (S110; YES), stores this as the clock quality (S111).

Moreover, the node E, if this [quality request] is judged not to be what is sent in the same direction as the previous [quality request] and from the same source node identifier (S106; NO), calculates the clock quality (S109), and stores this clock quality (S111).

Then, the node E, when the timer previously started up expires, determines the worst value in the stored clock qualities as the clock quality in the self-node (S112). Then, the determined clock quality is set in the [quality response] and then sent (S113). To be specific, the node E stores the [quality request] sent from the same source node identifier for the preset fixed period, and determines the worst value in the clock qualities stored after an elapse of the fixed period as the clock quality in the self-node.

Further, in the case of receiving the plurality of [quality requests] from the same source node identifier and transferring the [quality request] in the direction other than the direction of receiving the [quality requests], the [quality request] is so controlled as to be transferred only when better than the accumulated clock quality in the already-transferred [quality request].

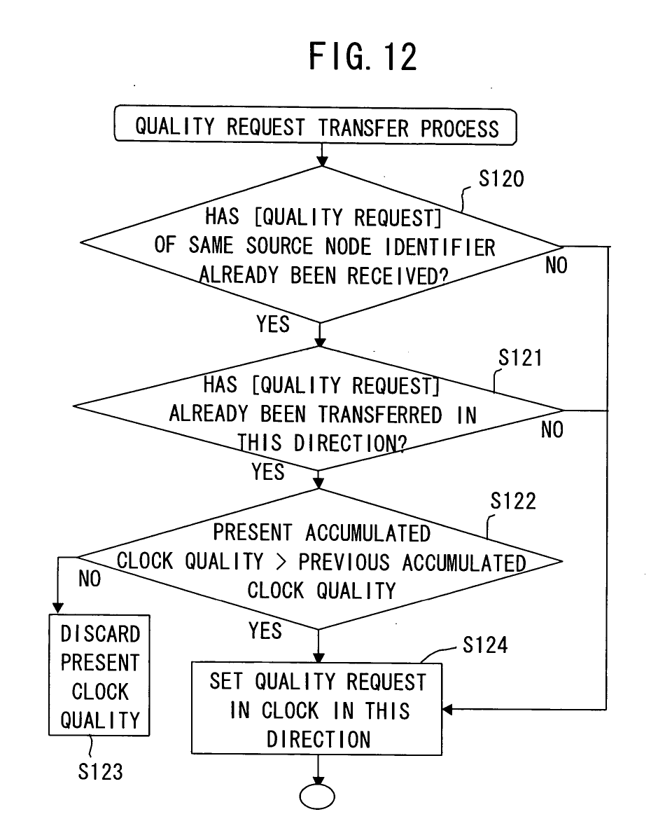

An operation of the node E in this case will be explained with reference to FIG. 12. FIG. 12 is a flowchart of an operation related to a [quality request] transfer process of each node having received the [quality request].

The node E, when receiving the [quality request], judges whether the [quality request] from the same source node identifier has already been received or not (S120). The node E, if already received (S120; YES), judges whether the [quality request] has already been transferred or not (S121). Then, if already transferred (S121; YES), the node E compares the accumulated clock quality when transferring the [quality request] last time with the accumulated clock quality of this time (S122).

If it proves from this comparison that the accuracy of the accumulated clock quality of this time is high (S122; YES), the node E sends the [quality request] in which the accumulated clock quality of this time is set (S124). Herein, if the accumulated clock quality of this time is worse than the clock quality of the last time (S122; No), the node E discards the present clock quality (S123).

Note that if the [quality request] of the same source node identifier is not yet received (S120; NO), or if the [quality request] is not yet transferred (S121; YES), the node E sets the [quality request] in the clock in this direction and sends the [quality request] (S124).

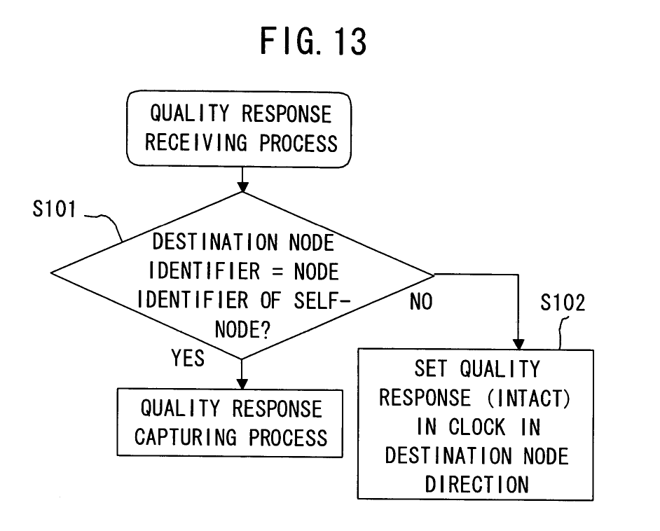

Further, the clock signal, in which the [quality response] 51 sent by the node E is set, is received by the sub-master station A via the node B. An operation of the node B having received the [quality response] 51 at this case will be explained with reference to FIG. 13. FIG. 13 is a flowchart of the operation of the node having received the [quality response].

The node B having received the [quality response] 51 extracts the [destination node identifier] set in the [quality response] 51, and judges whether or not the extracted node identifier is the identifier of the self-node (S101).

The node B, when judging that the extracted node identifier is not the identifier (node B: 0x0002) of the self-node (S101; No), sets the [quality response] as it is in the clock signal to be sent in the direction of the extracted node identifier and sends this [quality response] (S102). Namely, the node B, if the node other than the destination node identifier set in the [quality response] receives this [quality response], sets the [quality response] as it is in the clock signal in the direction of the destination node identifier. At this time, the destination node identifier direction is obtained from identifier-to-source mappings between the source node identifiers and the clock sources of the transmission sources, which are stored in the clock source table shown in FIG. 10.

Thus, when the [quality request] is sent to each node from the sub-master station A, each node having received this [quality request] sends the [quality response] to the sub-master station A. Namely, the nodes B, C, D, F also send the [quality response] to the sub-master station A by the same operation as the node E explained previously does.

Through this operation, the sub-master station A defined as a transmission source of the [quality request] adds up the clock qualities set in the intra-clock overheads of the [quality responses] sent from the other nodes B through F, and determines the worst value among those clock qualities as a clock supply quality in the sub-master station A.

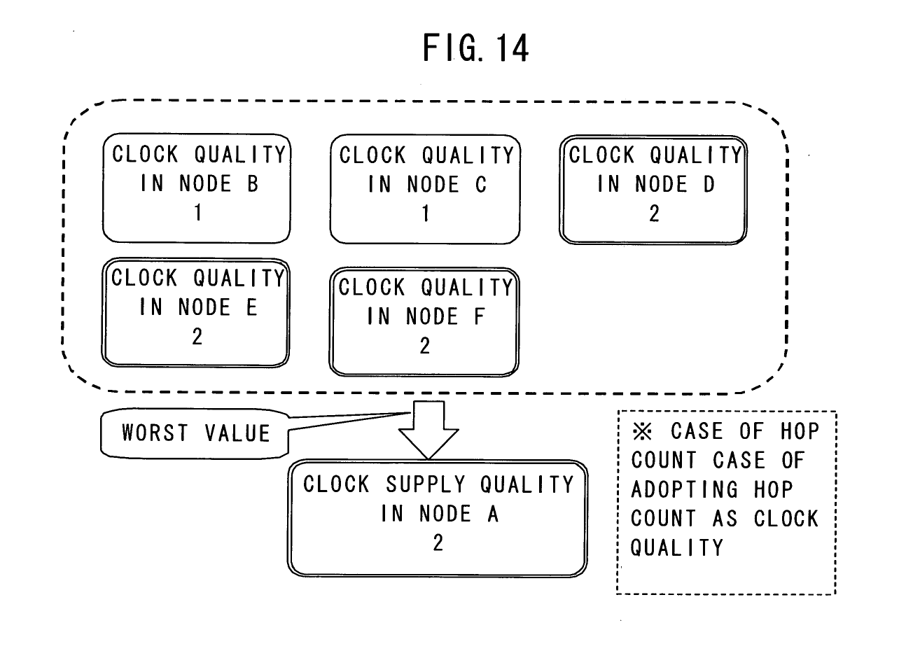

FIG. 14 shows a clock supply quality determination method in the sub-master station A. The sub-master station A, the hop count being used as the clock quality in the embodiment, extracts the worst value from the clock qualities (hop counts) of the nodes B through F, and determines “2” as the clock supply quality in the sub-master station A as shown in FIG. 14.

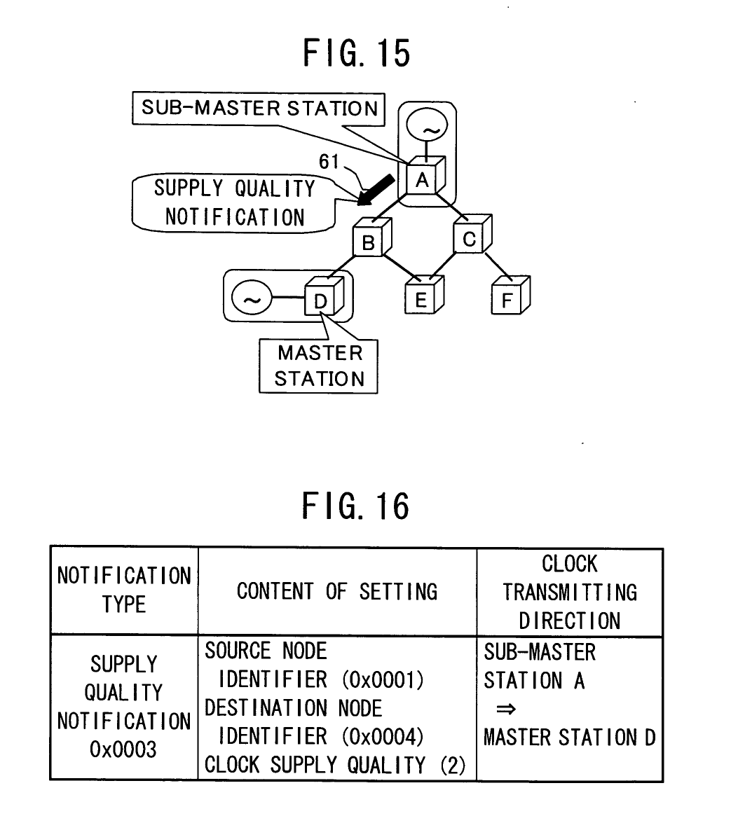

The sub-master station A, when determining the clock supply quality, sets the [supply quality notification] in the intra-clock overhead that is sent in the direction of the master station D. FIG. 15 shows how the sub-master station A sends [supply quality notification] 61. FIG. 16 shows contents set in the intra-clock overhead of the [supply quality notification] 61 sent by the sub-master station A.

As shown in FIG. 16, the sub-master station A, on the occasion of sending the [supply quality notification] 61, sets in the intra-clock overhead an identifier (0x0003) for specifying the supply quality notification, a previously-determined clock supply quality (2), a self-node identifier (0x0001) as the source node identifier and a node identifier (0x0004) of the present master station D as the destination node identifier.

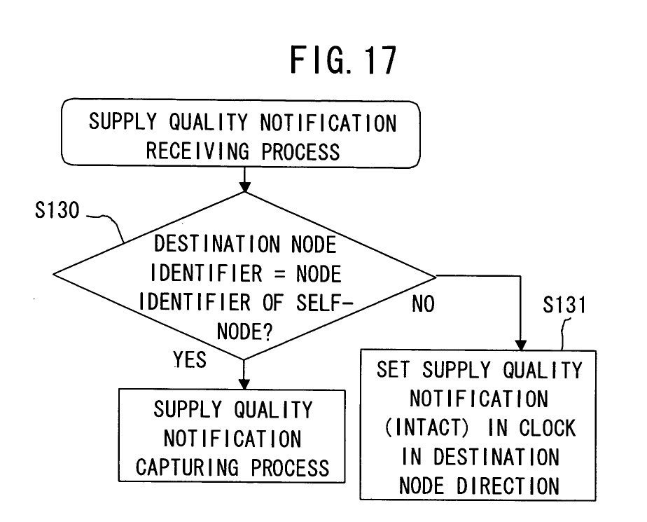

The master station D receives via the node B the clock signal (which will hereinafter be referred to as the [supply quality notification]) in which the [supply quality notification] 61 sent by the sub-master station A is set. An operation of the node B in this case will be explained with reference to FIG. 17. FIG. 17 is a flowchart of the operation related each node when receiving the [supply quality notification].

The node B having received the [supply quality notification] 61 extracts the destination node identifier set in the [supply quality notification] 61, and judges whether or not the extracted node identifier is the identifier of the self-node (S130).

The node B, when judging that the extracted node identifier is not the identifier (node B: 0x0002) of the self-node (S130; NO), sets the supply quality notification as it is in the clock signal to be sent in the direction of the extracted node identifier and sends this supply quality notification (S131).

Namely, the node B, if the node other than the destination node identifier set in the [supply quality notification] receives this [supply quality notification], sets the [supply quality notification] as it is in the clock in the direction of the destination node identifier. At this time, the destination node identifier direction is obtained from identifier-to-source mappings between the source node identifiers and the clock sources of the transmission sources, which are stored in the clock source table, shown in FIG. 10, in the self-node.

The master station D, upon receiving the clock signal in which the [supply quality notification] is set, adds up the clock supply qualities determined by the self-node (master station D) and the clock supply qualities in the sub-master station A that are set in the [supply quality notification], and determines the node having the best value among the clock supply qualities as the optimum master station.

In the embodiment, the sub-master station is only the node A, however, if there exist a plurality of sub-master stations, the master station receives pieces of [supply quality notification] from the plurality of sub-master stations, and adds up the respective clock supply qualities in the sub-master stations that are set in these pieces of [supply quality notification] and the clock supply qualities in the self-node, thereby determining the node having the best value as the optimum master station.

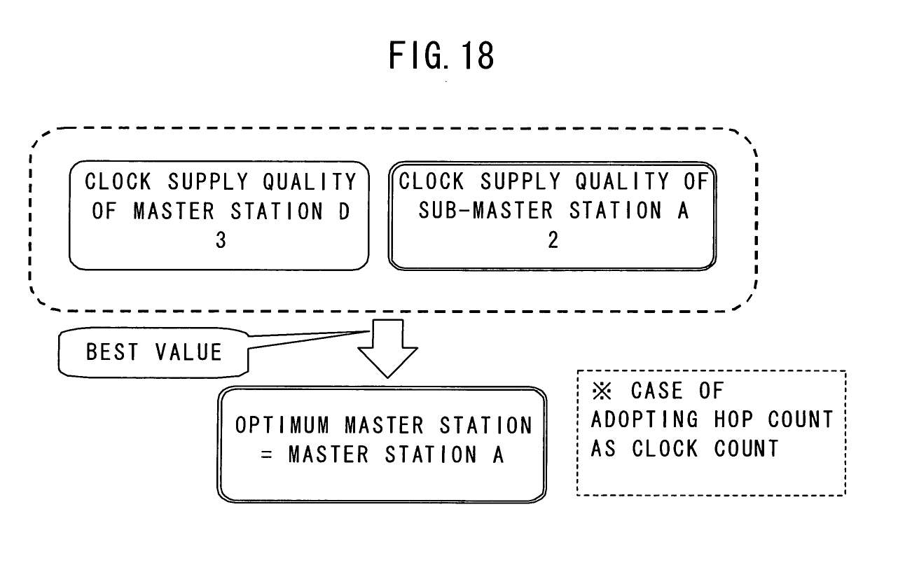

FIG. 18 shows an optimum master station determination method in the master station A. The master station A, the hop count being used as the clock quality in the embodiment, extracts the node having the best value from the clock supply qualities in the master station D and the sub-master station A, and determines the sub-master station A as the optimum master station, shown in FIG. 18.

Namely, in the embodiment, the hop count being adopted as the clock quality, the clock supply quality in the master station D is “3”, and the clock supply quality in the sub-master station A is “2”, thereby determining the sub-master station A as the optimum master station.

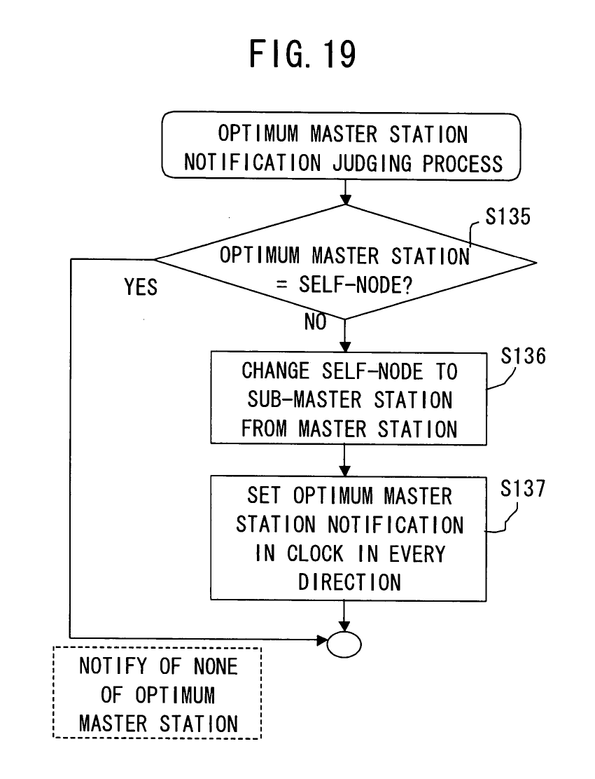

An operation of the present master station D that determines the optimum master station will be described with reference to FIG. 19. FIG. 19 is a flowchart of the operation of the master station that determines the optimum master station.

The master station D that determines the optimum master station judges whether the optimum master station is the self-node or not (S135). The master station D, when judging that the optimum master station is not the self-node (S135; NO), changes the setting of the selection clock priority levels in the self-node so that the first priority is given to the optimum master station, and changes the self-node to the sub-master station from the master station (S136).

Further, the master station D sets [optimum master station notification] in the intra-clock overhead that is sent to each node (S137). Note that if the present master station is the optimum master station (S135; YES), neither the change of the selection clock in the present master station nor the [optimum master station notification].

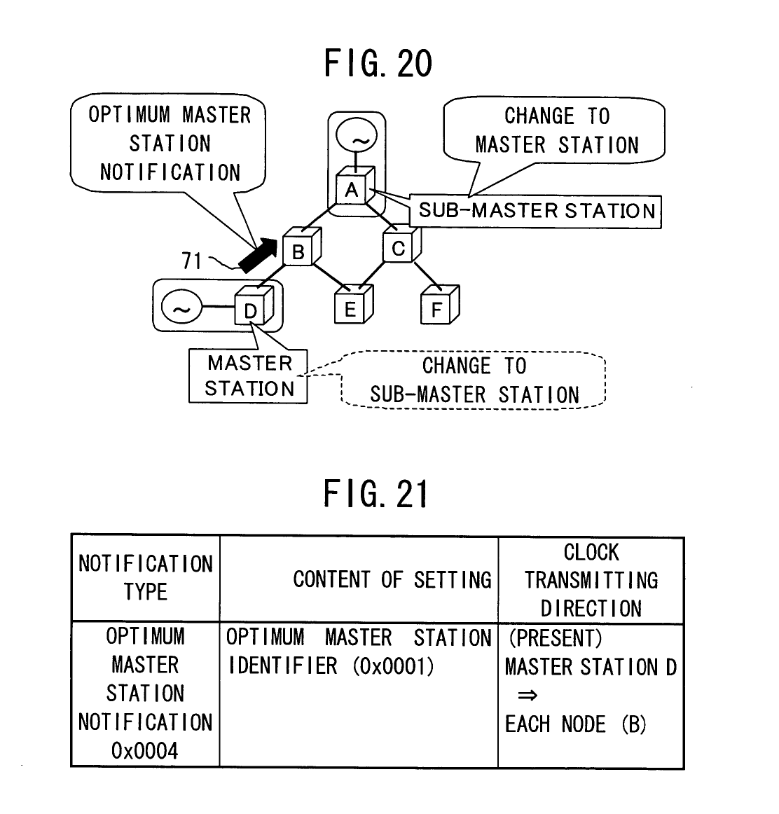

FIG. 20 shows how the [optimum master station notification] is conducted in the present master station D. FIG. 21 shows contents of the [optimum master station notification] set in the intra-clock overhead that is sent from the present master station D. An operation of the master station D in the embodiment will hereinafter be explained with reference to FIGS. 20 and 21

In the embodiment, since the sub-master station A is determined as the optimum master station, the present master station D changes the setting of the selection clock priority levels in the self-node so that the priority of the clock source sent from the present sub-master station A is changed to the first priority in the selection clocks, and the priority of the clock from the self-node is changed to a second priority.

The clock source to be transmitted from the present sub-master station A is acquired from the mapping table showing the identifier-to-source mappings between the source node identifiers and the clock sources of the transmission sources, which are stored in the clock source table, shown in FIG. 10, in the self-node. Further, the self-node is changed to the sub-master station from the master station.

Moreover, the present master station D, on the occasion of setting [optimum master station notification] 71, as shown in FIG. 21, sets an identifier (0x0004) for identifying the optimum master station notification and a node identifier (0x0001), as an optimum master station identifier, of the present sub-master station A determined as the optimum master station in the intra-clock overhead to be sent.

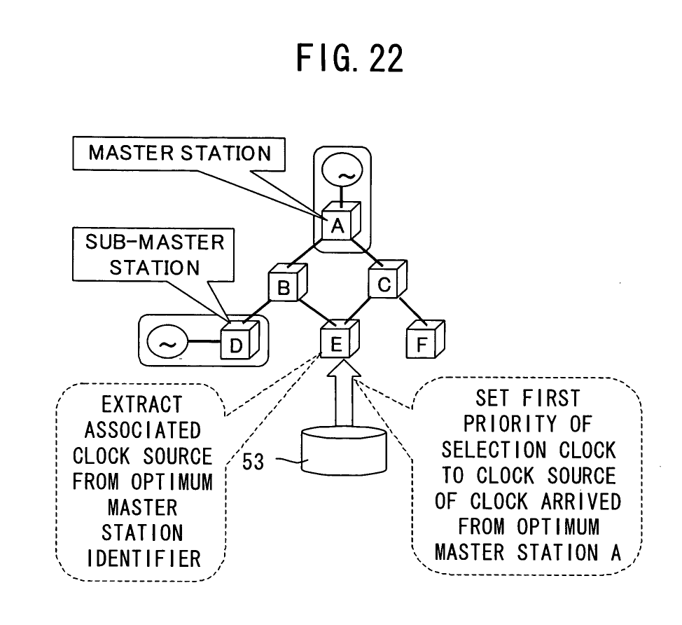

Each node having received the [optimum master station notification] 71 changes the setting of the selection clock priority levels in the self-node on the basis of the optimum master station identifier set in the clock signal. FIG. 22 shows how the selection clock priority levels are automatically changed in the node E. An operation in the case of the node E receiving the clock signal in which the (optimum master station notification] is set, will hereinafter be described with reference to FIG. 22.

The node E, upon receiving the clock signal in which the [optimum master station notification] is set, extracts an optimum master station identifier (node identifier “0x0001” of the node A) set in the clock signal. Then, the node E changes the priority of the clock source to be sent from the extracted node identifier of the optimum master station A to the first priority in the selection clocks.

The clock source sent from the optimum master station A is obtained from the identifier-to-source mappings between the source node identifiers and the clock source of the transmission sources, which are stored in the database within the self-node. Then, the node E sets the optimum master station notification as it is in the intra-clock overhead that is sent in the direction other than the direction of receiving the [optimum master station notification], and transfers the optimum master station notification to the other nodes.

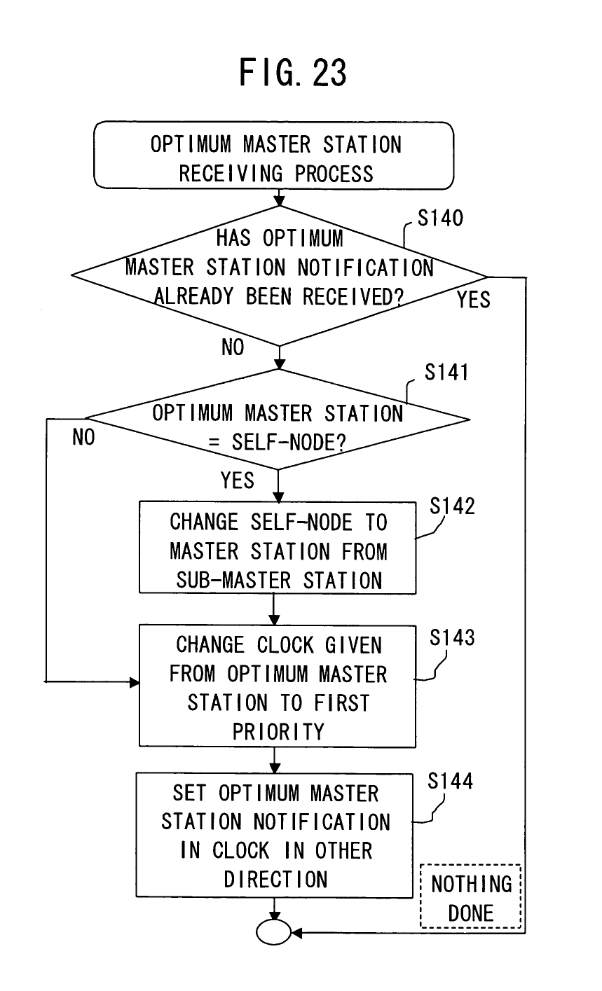

Moreover, for facilitating the understanding, the discussion made so far has dealt with the case in which the node E receives via the node B the [optimum master station notification] sent by the master station D, however, there is a case of receiving via the nodes A and C. Namely, it is considered that each node receives the [optimum master station notification] a plurality of times. An operation of the node E in this case will be explained with reference to FIG. 23. FIG. 23 is a flowchart of an [optimum master station notification] receiving process in each node.

The node E having received the [optimum master station notification] judges whether or not the [optimum master station notification] has already been received (S140). If already received (S140; YES), nothing is processed. Whereas if not yet received (S140; NO), it is judged whether the optimum master station set in the [optimum master station notification] is the self-node or not (S141).

If the optimum master station is not the self-node (S141; NO), the node E changes the selection clock priority levels so as to capture the clock with the first priority from the optimum master station (S143). Then, the node E sets the [optimum master station notification] as it is in the intra-clock overhead that is sent in the direction other than the direction of receiving the [optimum master station notification], and transfers the [optimum master station notification] to the other nodes (S144). If the optimum master station is the self-node (S141; YES), the node E executes the process (S142) of changing the self-node to the master station from the sub-master station before the processes (S143, S144).

Thus, in the case of receiving the [optimum master station notification] from the second time onward, the setting is ignored, and an endless loop of the [optimum master station notification] and futile processes can be reduced by effecting none of the transfer to the next node.

When the node A determined as the optimum master station receives the [optimum master station notification], the node is changed from the sub-master station to the master station, and the priority of the clock supplied within the self-node is changed to the first priority in the selection clocks.

### Operational Effect of Embodiment

In the system according to the embodiment, when the system constitution is changed, in the post-change system constitution, the optimum master station capable of supplying the optimum clock is determined, and the setting is automatically changed so that each node preferentially selects the clock supplied by this optimum master station.

For determining this type of optimum master station, the master station and the sub-master station having the clock sources send the [quality requests] (e.g., the [quality requests] 41, 42 sent by the sub-master station A) to the other nodes.

Each of the nodes having received the [quality requests] calculates the clock quality of the self-node from the information stored on the quality DB 113 and the information such as the accumulated clock quality, etc. set in the [quality request]. Then, the [quality response (e.g., the [quality response] 51 sent by the node E) in which this clock quality is set, is sent in the direction of the source node of the [quality request].

The master station and the sub-master station add up the [quality responses] sent by the respective nodes excluding the self-node, and determine the clock quality exhibiting the worst accuracy among the clock qualities set in the [quality responses] as the clock supply quality in the self-node.

The master station and the sub-master station, which have determined the clock supply quality, send the [supply quality notification (e.g., the [supply quality notification] 61 sent by the sub-master station A) in which the clock supply quality is sent in the direction of the master station.

The master station adds up pieces of [supply quality notification] sent by the individual clock supply nodes, and determines, as the optimum master station, the clock supply node exhibiting the highest supply clock accuracy among the clock supply qualities set in these pieces of [supply quality notification].

Thus, according to the embodiment, each of the nodes configuring the system transfer and receive the clock quality information ([quality request], [quality response], [supply quality notification]), and collect the clock qualities, etc. of the respective nodes. Therefore, the clock supply node exhibiting the highest supply clock accuracy can be automatically determined at all times as in the case of changing the network constitution.

Moreover, the master station, if the optimum master station is not the self-node, sends the [optimum master station notification] (e.g., the [optimum master station notification] 71 sent by the node D) in which the new optimum master station is set to each of the nodes within the system so as to change the optimum master station.

Then, each of the nodes having received this [optimum master station notification] changes the setting of the priority levels of the selection clocks so that the top priority is given to the [optimum master station] set in the [optimum master station notification].

Thus, in the embodiment, the clock supply node notifies each node of the optimum master station determined from time to time, and the node notified operates to capture the clock with the first priority, which is sent from this optimum master station. This enables automation of invariably synchronizing all the nodes within the system with the optimum clock.

Further, in the system according to the embodiment, each node which the clock quality is requested, in the case of including a different receiving direction from the quality request message receiving direction, the quality request message in this different direction. The [quality request] is thereby received by all the nodes not only in the network constitution (topology) in which the clock supply node is connected to each node in a peer-to-peer mode but also in the constitution (a ring type topology) in which the clock supply node is connected via other nodes.

Moreover, in the system according to the embodiment, if there exist other nodes between the clock supply node and the self-node, the node therebetween sets the clock quality in the self-node as the accumulated clock quality and transfers this clock quality to the next node. With this operation, each node can acquire accumulation data of the clock qualities till being reached to the self-node with respect to the clock supplied from the clock supply node. This enables each node to calculate a more precise clock quality.

Further, in the system according to the embodiment, each node, when transferring the quality request message of the clock from the clock supply node to the other nodes, transfers the quality request message only in such a case that the accumulated clock quality information contained in this message is better than the information in the message transferred last time with respect to the already-transferred quality request message. With this operation, even in the network constitution where each node receives the quality request message a plurality of times from one single clock supply node, the transfer of this message can be restrained down to the minimum required, and an increase in the futile network traffic can be prevented. Furthermore, in each node, the futile message process can be decreased.

<Processing Sequence>

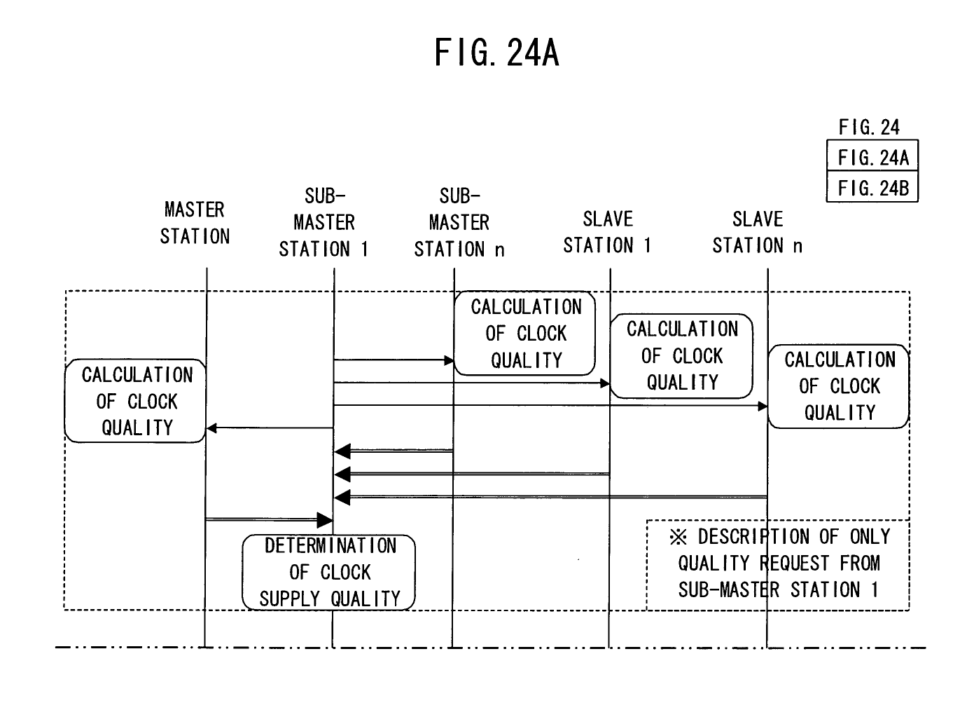

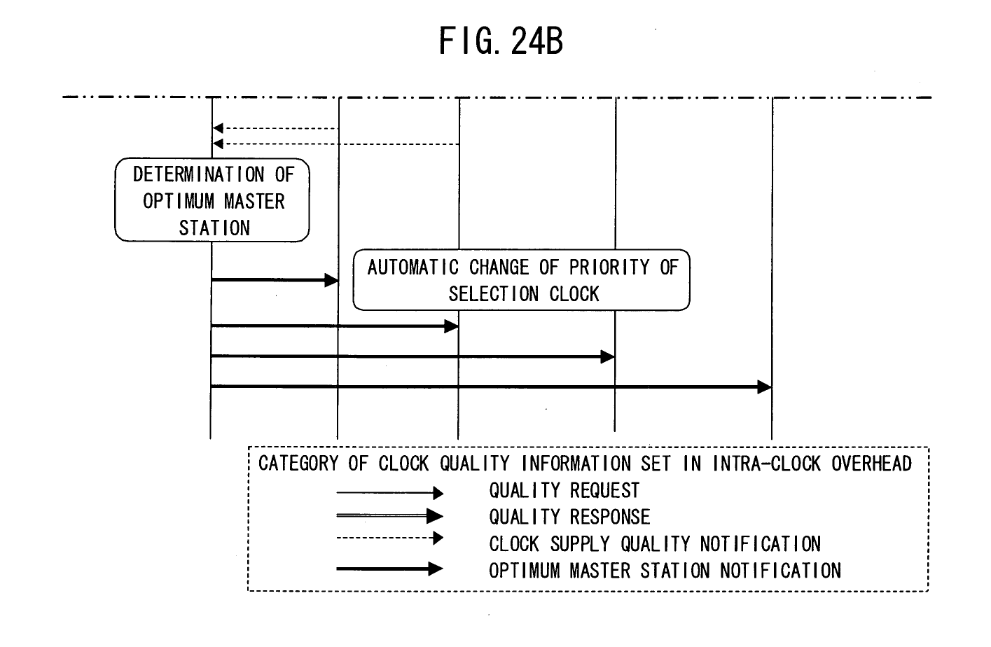

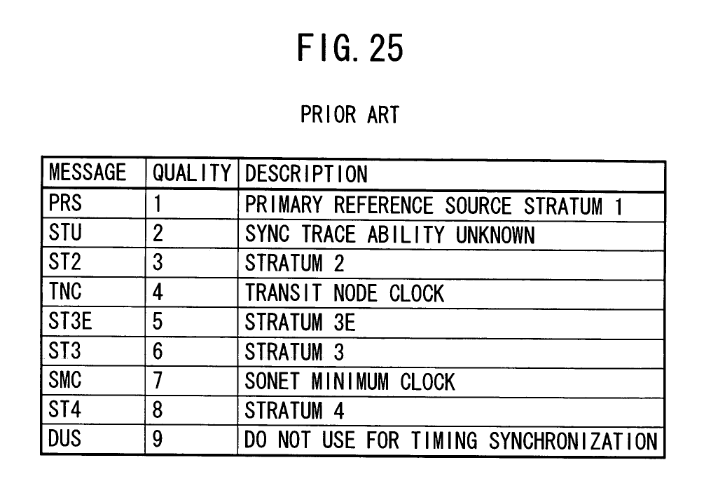

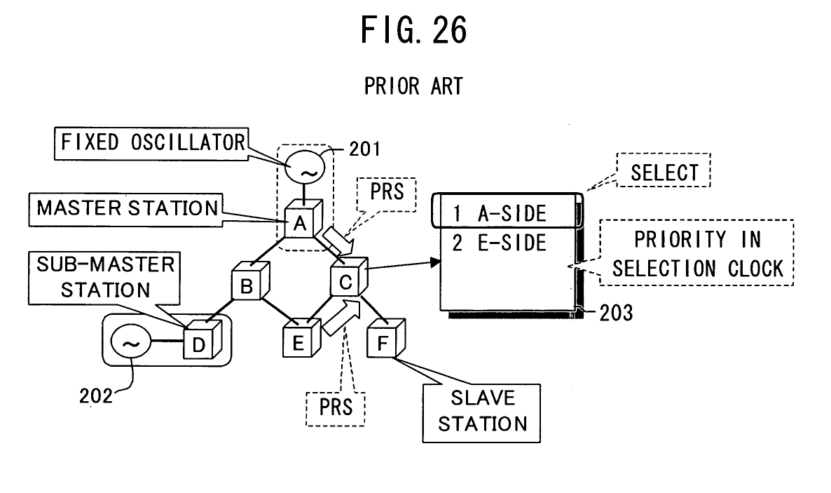

Next, a case in which there exist a plurality of sub-master stations will be described by way of a mode different from the embodiment of the present invention discussed above with reference to FIG. 24. FIG. 24 is a diagram showing a processing sequence in this case.

The master station and the sub-master stations 1 through n send the [quality requests] to the other nodes. FIG. 24 shows only the quality request sent from the sub-master station 1, and the following discussion proceeds in accordance with the illustration in FIG. 24 in order to maker the understanding easier.

The sub-master station 1 sends the [quality request] to the other nodes, i.e., the master station, the sub-master station n, the slave station 1 and the slave station n. Each of the nodes having received this [quality request] calculates the clock quality, sets the clock quality per node as a result of this calculation, and sends the [quality response] to the sub-master station 1. The sub-master station 1 having received the [quality responses] from the respective nodes adds up these [quality responses], and determines the clock supply quality.

The sub-master stations 1 through n, which have determined the clock supply quality, send the [supply quality notification] with the clock supply quality set therein to the master station. Then, the master station adds up these pieces of [supply quality notification], and determines the optimum master station. Finally, the master station sends the [optimum master station notification] in order to notify the other nodes of the optimum master station.

Thus, the system according to the present invention is capable of always selecting the optimum master station even in the case there exist the plurality of sub-master stations, and synchronizing all the nodes within the system with the clock supplied by this optimum master station.

<Modified Example>

The embodiment of the present invention adopts the scheme that each clock supply node sends the [supply quality notification] to the master station, and the master station determines the optimum master station, however, the sub-master station may also determine the optimum master station.

Moreover, in the embodiment of the present invention, the node-to-node relay count (hop count) is adopted as the clock quality, however, there may also be utilized pieces of information serving as a criterion in terms of measuring the clock quality, such as a connection distance from the clock supply node, a circuit alarm occurrence count, a circuit switchover count, etc.

What is claimed is:

1. A synchronous transmission network system including a plurality of nodes including a plurality of clock supply nodes, all the plurality of nodes being synchronized with a clock supplied from one of the plurality of clock supply nodes as a master to perform data transmission,
each of the plurality of clock supply nodes comprising:
a transmission module for transmitting a quality request message for checking a quality of the clock supplied from the clock supply node itself to all other nodes;
a receiving module for receiving quality response messages each containing clock quality information representing the clock quality from all the other nodes;
a quality determination module for determining the quality of the clock supplied by the clock supply node itself as clock supply quality information on the basis of the quality response messages received by the receiving module;
a notifying module for notifying, if the clock supply node itself is not the master, other clock supply node serving as the master of the clock supply quality information; and
a node determination module for determining, if the clock supply node itself is the master, an optimum clock supply node supplying the best clock supply quality on the basis of the clock supply quality information which each of other clock supply nodes has notified of and the clock supply quality information of the clock supply node itself that is obtained by the quality determination module of the clock supply node itself.

2. A synchronous transmission network system according to claim 1, each of the clock supply nodes further comprising:
a judging module for judging whether or not the optimum clock supply node determined by the node determination module is the clock supply node itself; and
an optimum master station notifying module for sending, if the judging module judges that the optimum clock supply node is not the clock supply node itself, an optimum master station notifying message for indicating a receipt of a clock supply from the optimum clock supply node toward all the other nodes.

3. A synchronous transmission network system according to claim 1, each of the nodes including:
a quality request receiving module for receiving the quality request message;
a quality response creation module for creating the quality response message responding to the quality request message received by the quality request receiving module;
a quality response transmission module for transmitting the quality response message, addressed to a source node of the quality request message, in a direction of receiving the quality request message; and
a quality transfer module for transferring, if the quality request receiving module has a receiving direction different from the quality request message receiving direction, the quality request message in the different receiving direction.

4. A synchronous transmission network system according to claim 2, each of the nodes including:
a registration module registered with the optimum clock supply node;
a clock selection module for selecting the clock supplied from the optimum clock supply node registered in the registration module from the clocks supplied from the respective clock supply nodes; and
a registration control module for registering, when receiving the optimum master station notifying message, the optimum clock supply node specified by the optimum master station notifying message in the registration module.

5. A synchronous transmission network system according to claim 3, each of the nodes further including:
a quality information extracting module for extracting, when receiving the quality request message, accumulated clock quality information contained in the quality request message; and
a quality information calculating module for calculating the clock quality information in the node itself on the basis of the accumulated clock quality information,
wherein the quality response creation module, when creating the quality response message, includes the clock quality information being calculated by the quality information calculating module in the quality response message, and
wherein the quality transfer module, after including the clock quality information calculated by the quality information calculating module as the accumulated clock quality information in the quality request message, transfers the quality request message.

6. A synchronous transmission network system according to claim 5, each of the nodes further including:
a writing module for writing, when the quality transfer module transfers the quality request message, a transmission source of the quality request message to be transferred, a transferring direction and the accumulated clock quality information contained in the quality request message to a storage module; and
a reading out module for reading out, before being written by the writing module, the transmission source of the quality request message to be transferred and the accumulated clock quality information corresponding to the transferring direction from the storage module, and
wherein the quality transfer module, before transferring the quality request message, compares a quality specified by the accumulated clock quality information contained in the quality request message to be transferred this time with a quality specified by the accumulated clock quality information read out by the reading out module, and, if the former quality is better than the latter quality, transfers the quality request message.

7. A clock supply node, set in a network including a plurality of nodes, and supplying the plurality of nodes with a clock which the plurality of nodes operate in synchronization with, comprising:
a transmission module for transmitting a quality request message for checking a quality of a clock supplied from a clock supply node itself toward the plurality of nodes;
a receiving module for receiving a quality response message containing clock quality information representing the quality of the clock from each of the plurality of nodes;
a quality determination module for determining the quality of the clock supplied by the clock supply node itself as clock supply quality information on the basis of the quality response message received by the receiving module;
a notifying module for notifying, if the clock supply node itself is not a master for supplying the clock to the plurality of nodes in preference to other clock supply nodes of the clock supply node itself included in the plurality of nodes, the other clock supply node serving as the master of the clock supply quality information; and
a node determination module for determining, if the clock supply node itself is the master, an optimum clock supply node supplying the best clock supply quality on the basis of the clock supply quality information which each of other clock supply nodes has notified of and the clock supply quality information of the clock supply node itself that is obtained by the quality determination module of the clock supply node itself.

8. A method of determining an optimum clock supply node in a synchronous transmission network system including a plurality of nodes including a plurality of clock supply nodes, and synchronizing all the plurality of nodes with a clock supplied from one of clock supply nodes as a master, the method making each of the clock supply nodes executing processes comprising:
transmitting a quality request message for checking a quality of a clock supplied from a clock supply node itself toward all other nodes;
receiving a quality response message containing clock quality information representing the quality of the clock from all the other nodes;
determining the quality of the clock supplied by the clock supply node itself as clock supply quality information on the basis of the quality response message received by the receiving module;
notifying, if the clock supply node itself is not a master, the other clock supply node serving as the master of the clock supply quality information; and
determining, if the clock supply node itself is the master, an optimum clock supply node exhibiting the best clock supply quality on the basis of the clock supply quality information which each of other clock supply nodes has notified of and the clock supply quality information of the clock supply node itself that is obtained by the quality determination module of the clock supply node itself.
